(19) United States
(12) Patent Application Publication
(10) Pub. No.: US 2010/0259498 A1
(43) Pub. Date: Oct. 14, 2010

(54) USER INTERFACE FOR A TACTILE SENSING DEVICE

(76) Inventors: Barak Harison, Be'er Ya'akov (IL); Elad Harison, Hod Ha'Sharon (IL)

Correspondence Address: Allan C. Entis Ph.D., Intellectual Property Ltd., 6 Raoul Wallenberg Street, Ramat Hachayal, Tel Aviv, 69719, IL

(21) Appl. No.: 12/758,825

(22) Filed: Apr. 13, 2010

Related U.S. Application Data
(60) Provisional application No. 61/169,115, filed on Apr. 14, 2009.

(51) Int. Cl. G06F 3/041; H04Q 5/22; G06F 3/01

(52) U.S. Cl. 345/173; 340/10.1; 715/702

(57) ABSTRACT

A user interface for a tactile sensing device has a cover that is placed on the tactile sensing device. The tactile sensing device communicates with a host device that runs software programs and the cover has an identifier that provides identification data of the cover that is automatically transmitted to the host device.

### CROSS-REFERENCES TO RELATED APPLICATIONS

The present application claims benefit under 35 U.S.C. §119(e) of US Provisional Application 61/169,115 filed Apr. 14, 2009, the entire content of which is incorporated herein by reference.

### BACKGROUND

The present invention relates to a user interface for a tactile sensing device and in particular to a user interface that includes a cover that is placed upon the tactile sensing device.

Such a cover may define tactile operative regions upon the sensing device and may be overlaid upon a tactile sensing device such as a graphics tablet, a touchpad, a touch screen display, (etc.) in order to provide a user interface (or an additional user interface) with a software program that runs on a host device such as a host computer and/or a CPU that is associated with the tactile sensing device.

U.S. Pat. No. 7,106,220 describes a tactile sensing device that is connected to a host computer upon which different overlays may be placed for different interactive software applications which are run by the host computer. Use of the device is performed by launching a particular program on the host computer which directs the user to place a particular overlay onto the touchpad. An identification process which serves to instruct the host computer which overlay has been placed over the touchpad is performed by the user running his finger over identification members on the overlay which are sensed by the touchpad and define a code that is read by the host computer.

### SUMMARY

The following embodiments and aspects thereof are described and illustrated in conjunction with systems, tools and methods which are meant to be exemplary and illustrative, not limiting in scope.

In an embodiment of the present invention there is provided a device that functions as a cover and/or an overlay for a tactile sensing device. The tactile sensing device may be a touchpad, a tablet, a graphics tablet, a touch screen display, (etc.); and the tactile sensing device may be of the kind that is embedded or associated with a host device that may include a host computer and/or a CPU (or the like) that is adapted to run software programs and/or applications. The cover may be wearable and/or replaceable on the tactile sensing device and may be made from materials such as plastic, nylon, silicon, a fabric or optionally any flexible or elastic material with graphics and/or text printed on it. The cover may also have a three dimensional and optionally flexible interface that can be pressed by the user. The graphics and/or text on the cover and/or the three dimensional surface of the cover define particular areas of the cover that by touching them with the fingers or with an object, the user exercises pressure on the tactile sensing device. By transferring the pressure through the cover and detecting it by the tactile sensing device, the user may operate different functions of devices, external devices, data processing systems and/or applications that are controlled by (or associated with) the tactile sensing device.

Preferably, the cover has an identifier that serves to identify the cover by for example storing and transmitting data, such as a digital identifier and/or identifiers of the cover to a receiver that is associated with the tactile sensing device, and/or with devices that are associated with the tactile sensing device, and/or applications with which the cover is meant or able to operate with. In an embodiment, the identifier is adapted to automatically transmit the identification data without requiring the users assistance and the receiver is adapted to automatically receive the identification data and communicate it onwards towards the host device.

Optionally, such an identifier can be a wireless identifier that may include, but is not limited to, an RFID tag that can be detected by a device with an RFID tag reader that is associated with the tactile sensing device and the data transmitted from the RFID tag of the cover can be read by the RFID tag reader. In other examples, the wireless identifier may include radio frequency (RF) connections, a magnetic badge, a token, infrared, optical (barcode reader) of any other wireless device. The radio frequency (RF) connections that may be used in accordance with such embodiments of the present invention include, but are not limited to, Ethernet, Bluetooth, RTM, and the like.

In some embodiments, a wireless identifier of a given cover that is being urged towards a tactile sensing device is adapted to transmit identification data at an intensity that is for example tuned to be received by the receiver only when the distance of the given cover (or its wireless identifier) from the tactile sensing device (or the receiver) is below a given proximity to so as to ensure that only the identification data of the given cover is received by the receiver (and not for example an identification data of another cover that rests aside the tactile sensing device). Optionally, such a given proximity may be several tens of centimeters, several centimeters or several millimeters.

In an embodiment, the identifier may be adapted to automatically transmit identification data to the receiver by physical interfaces such as a given pattern of bulges on the cover that abut the tactile sensitive area of the tactile sensing device when the cover is laid thereupon and thereby automatically transmit identification data that is defined by the given pattern.

In an embodiment, the identifier of the cover transmits a signal that is optionally in the form of digital data (for example a defined string of letters and digits) that is received by the receiver that is optionally on the tactile sensing device. The receiver may then transfer the received data to an optional controller of the tactile sensing device and then the digital data may be transferred to a host device such as a host computer or a CPU for being processed by for example an installed driver or a routine running on the host device. On the basis of the received data, the driver (or routine or software program associated with the driver) may identify the details of the cover that is attached to the tactile sensing device and operate an appropriate software program (that fits and can be controlled by the tactile sensing device and the cover as its user interface). In an embodiment, on the basis of the received data, the driver (or routine or a software program associated with the driver) may verify that a software program already running on the host device is one that fits the cover being used and may provide indication which appropriate software program should be opened by the user.

Optionally, the cover defines areas on the tactile sensing device that operate different functions of for example external devices, data processing systems and applications. For example, pressing a particular area of the cover optionally transmits the amount of pressure being applied to the equivalent area on the tactile sensing device and operates a low tone sound in the host device, while the rest of the areas of the cover (and the equivalent areas of the tactile sensing device) operate a high tone in the host device when pressed. In an embodiment, the volume of the tone being played may be in proportion to the amount of pressure that the user generates while touching the cover that is consequently exercised onto the tactile sensing device.

Typically, the surface of a tactile sensing device is a flat and a physically unmarked surface and thereby does not provide indications to a user where and how to press it in order to operate a required functionality that the user may wish to achieve on a software program that is associated with the tactile sensing device.

The cover in accordance with the present invention may enhance the use of such a flat and unmarked surface by indicating with graphical, textual and/or two or three dimensional design elements which areas of the surface should be pressed in order to operate particular functions in the host device.

Optionally, the cover may present numerous ways and possibilities to operate software programs via a tactile sensing device by designing, producing and mounting each cover as a user interface that uniquely and appropriately matches the needs and the requirements of operating each software program and application.

Further optionally, the cover is replaceable and can be taken off the tactile sensing device so that another cover with a different interface can be mounted on the tactile sensing device to operate the software program that its user interface matches.

Optionally, by identifying the cover it is possible to provide to the users visual and/or sense-based indications which areas of the cover (that correspond to the areas of the tactile sensing device) can operate different functions of the software program that the cover matches and how to press them in order to operate the program. The cover by being replaceable enables to define with each new cover that is used, different areas of the tactile sensing device in varying manners to suit the needs of, for example, the software program that it operates.

In embodiments of the present invention, the tactile sensing device is operated by pressing the cover with fingers or with any object. In some embodiments, the cover is adapted to transfer to the tactile sensing device the angle and direction of the pressure of the user's finger/s or pressed objects. In some embodiments, the cover is adapted to transfer to the tactile sensing device multiple areas of pressure that are applied thereon at the same time (by for example the user pressing the cover with several fingers and/or objects).

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 shows a perspective view of an embodiment of a cover in accordance with the present invention being shown separated and above a tactile sensing device;

FIG. 2 shows a side view of the cover mounted on the tactile sensing device;

FIG. 3 shows a section of FIG. 2;

FIG. 4 shows a perspective view of another embodiment of a cover mounted on a tactile sensing device; and

FIG. 5 shows a flow diagram that delineates optional methods of use of a cover in accordance with the present invention with a tactile sensing device and/or software programs associated with the tactile sensing device.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

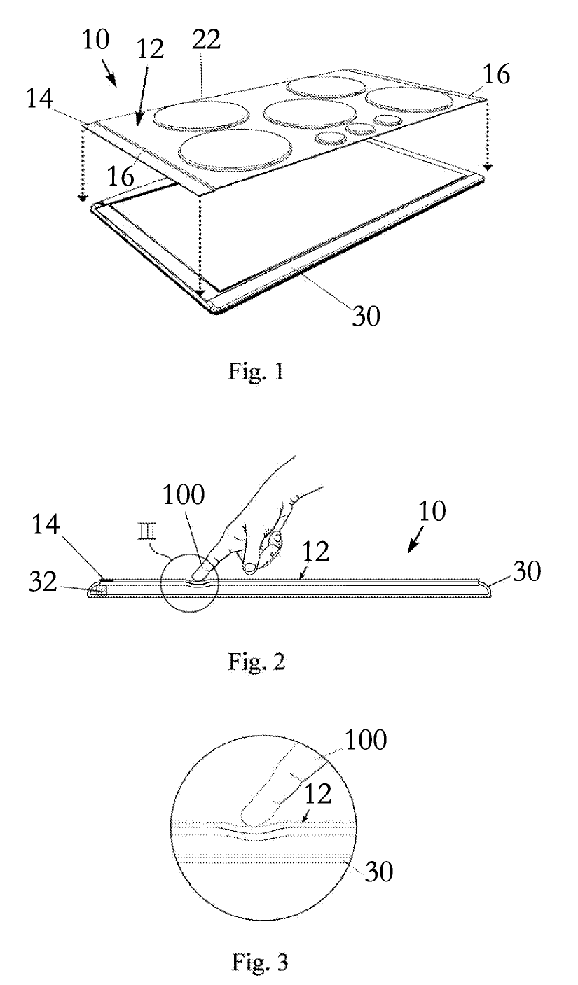

Attention is first drawn to FIG. 1. A user interface includes a cover 10 for a tactile sensing device 30 that has an upper surface 12 that may include graphics and/or text and/or three-dimensional design elements 22. The cover 10 is for example made of plastic, nylon, silicon, a fabric or optionally any flexible or elastic material (etc.); and has an identifier 14 that is optionally mounted thereon and an optional solid frame 16 made of plastic, iron, wood or any other material, that is adapted to assist the mounting of the cover 10 on the tactile sensing device 30.

Optionally, the tactile sensing device 30 may be associated with a host device such as a computer (not shown) when such sensing device 30 is for example in the form of a graphics tablet. Also optionally, the tactile sensing device 30 may be embedded with (or integrally formed with) a host device such as a CPU (not shown) when such sensing device 30 is for example in the form of a touchscreen.

Such host devices are of the type that are adapted to run software programs and/or applications that are at least partially controlled or operated by the tactile sensing device 30.

It should be noted that directional terms appearing throughout the specification and claims, e.g. “forward”, “rear”, “up”, “down” etc., (and derivatives thereof) are for illustrative purposes only, and are not intended to limit the scope of the appended claims. In addition it is noted that the directional terms “down”, “below” and “lower” (and derivatives thereof) define identical directions.

Attention is additionally drawn to FIGS. 2 and 3. The cover 10 is mounted to a tactile sensitive area of the tactile sensing device 30 to serve as a user interface by indicating the location and/or the amount and/or the results of pressure that is applied by a user 100 on the surface 12 of the cover 10, and consequently on the tactile sensing device 30. The cover 10 is placed on the tactile sensing device 30 to designate operative areas of the tactile sensing device 30 on which the user 100 may exercise pressure through pressing his/her fingers or an object (not shown) against the cover 10 to generate output that operates external devices, data processing systems and/or applications.

These designated areas are defined by optionally by any flexible material with graphics and/or text and/or three-dimensional design elements 22 that are mounted or formed on tactile sensing device 30 to instruct the user which the areas to touch in order to appropriately operate the external devices, data processing systems and/or applications that run on the host device (not shown). The cover 10 may be replaceable by another cover or can be removed from the tactile sensing device 30 and optionally the frame 16 assists in mounting the cover 10 on tactile sensing device 30.

The identifier 14 identifies the cover 10 by storing and optionally transmitting data, such as a digital identifier and/or identifiers of the cover 10 to a receiver 32 of the user interface that is optionally located on the tactile sensing device 30 when the cover 10 is placed optionally in proximity to tactile sensing device 30 or when the cover 10 is mounted to tactile sensing device 30. The data transmitted by the identifier 14 and received by receiver 32 may be communicated to external devices, data processing systems and applications that run on the host device (not shown).

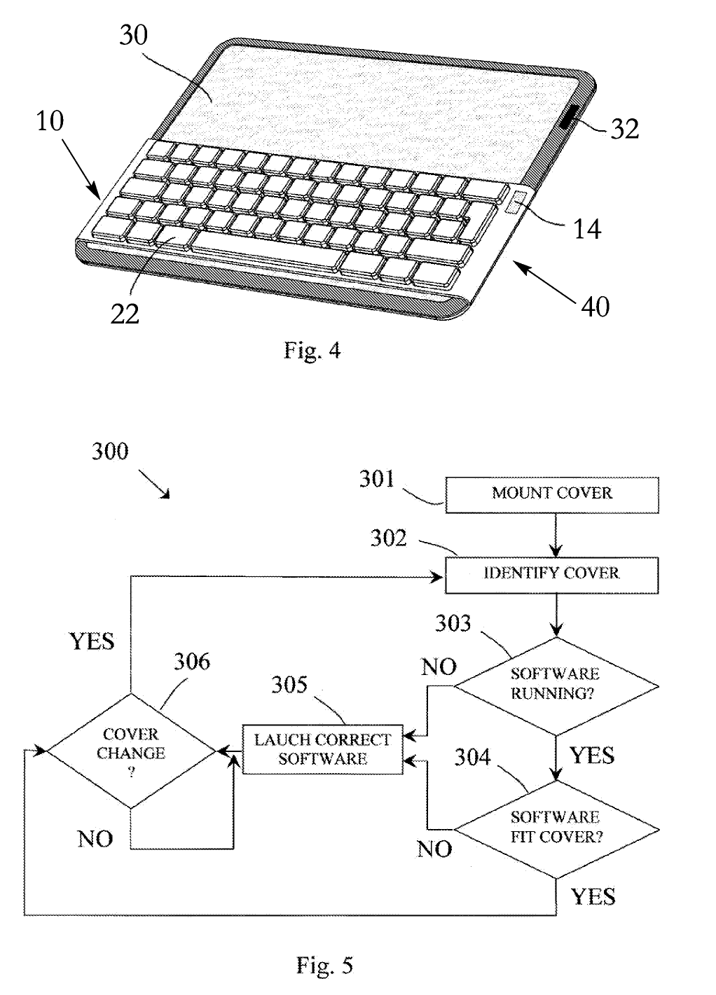

Attention is drawn to FIG. 4. In an embodiment, a cover 10 is mounted on a tactile sensing device 30 to provide a user interface 40 that is adapted to interact with software programs that run on the host device (not shown). The user interface 40 may include design elements 22 such as keys of for example a keyboard and by pressing such design elements 22 the user may operate functions in the software program that runs on the host device such as causing a letter that is graphically displayed on a specific design elements 22 (e.g. key) to appear in a word processor computer application that is run by the host device.

In non binding examples, the tactile sensing device 30 may optionally be a tablet and the host device may be a computer such as a personal computer that communicates with the tablet; and further optionally the tactile sensing device 30 may be a touchscreen that is embedded (or integrally formed) with a CPU such as for example a PDA, a mobile communication device, a handset with a touchscreen, a media player with a touchscreen (or the like).

In an embodiment, the cover 10 may include an identifier 14 that is adapted to identify to the cover 10 to the tactile sensing device 30 or to devices associated with the tactile sensing device 30 (such as the host device that runs the software programs or other devices or means that may be associated with or coupled to the tactile sensing device 30). A receiver 32 that may be embedded in the tactile sensing device 30 (or in devices associated therewith), or may be a part of the user interface 40 that has been configured to communicate with the tactile sensing device 30 (or with devices associated therewith); may identify data transmitted by the identifier 14 and transfer that data optionally to a driver or a routine that runs on the host device.

The driver or routine in turn may optionally trigger the launch of a software program that is adapted to function with the identified cover 10 such as a word processor program when for example the identified cover 10 is in the form of a keyboard. If for example prior to the mounting of the cover 10 on the tactile sensing device 30 another program has already been launched, the driver or routine may indicate to the user that a wrong program is running and/or may recommend or automatically initiate the launch of the correct program.

In some embodiments of the invention, use of the cover 10 and/or the interaction of the cover 10 with the tactile sensing device 30 and/or with software drivers, routines or programs associated therewith may be described by a flow diagram similar to the flow diagram 300 shown in FIG. 5. In block 301 the step of placing the cover 10 on the tactile sensing device 30 is represented. In block 302, data optionally transmitted by the identifier 14 of the cover 10 is received by the receiver 32 associated with the tactile sensing device 30 and an identification of the cover 10 is optionally performed by a driver or routine that is installed (or is run) on the host device associated with the tactile sensing device 30.

In decision block 303 an optional query whether a software program is already running on the host device is performed. If no software program is already running then optionally a driver or routine installed (or run) on the host device may in block 305 trigger the launch of the correct software that fits the cover that was identified in step 302 and then in optional decision block 306 a periodic query whether the cover on the tactile sensing device 30 has been changed is performed.

If on the other hand in decision block 303 it is determined that a software program is already running on the host device then in decision block 304 it is optionally checked whether the software already running fits the cover 10 identified in step 302. If it does not fit then an indication may be triggered to inform the user of incompatibility between the software and the cover and optionally the running software may be automatically or manually shut down and then in step 305 the correct software launched.

If on the other hand in decision block 304 it was found that the software already running on the host device fits the identified cover then decision block 306 may optionally be reached where the periodic query if the cover has changed is performed. If in decision block 306 the result is negative then a loop may be activated to periodically perform this query. If on the other hand in decision block 306 the result is positive then block 302 may be returned to in order that the newly placed cover may be identified and so on.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although the present embodiment has been described to a certain degree of particularity, it should be understood that various alterations and modifications could be made without departing from the scope of the invention as hereinafter claimed.

1. A user interface for a tactile sensing device comprising a cover that is adapted to be placed over at least a portion of a tactile sensitive area of the tactile sensing device,
the tactile sensing device being in communication with a host device that is adapted to run software programs and the cover comprises an identifier that provides identification data of the cover that is automatically communicated to the host device.

2. The user interface according to claim 1 comprising a receiver that is associated with the tactile sensing device, said receiver being adapted to receive the identification data of the cover and communicate it to the host device.

3. The user interface according to claim 2 wherein the identifier is a wireless identifier that is adapted to transmit identification data that is received by the receiver also when the cover is still being urged towards the tactile sensing device and before being placed thereon.

4. The user interface according to claim 3, wherein the identification data communicated to the host device is adapted to urge the launch of a software program on the host device that is adapted to operate with the identified cover.

5. The user interface according to claim 3, wherein the wireless identifier communicates with the receiver via at least one of the following: RFID communication, radio frequency (RF) connections, a magnetic badge, a token, infrared communication and/or optical communication.

6. The user interface according to claim 2, wherein the identifier is adapted to transmit the identification data to the receiver by a physical interface that is triggered when the cover abuts the tactile sensing device.

7. A method of using a user interface with a tactile sensing device comprising the steps of:
providing a tactile sensing device that communicates with a host device that is adapted to run software programs,
providing a cover of the user interface that is urged to be placed on the tactile sensing device, wherein said cover comprises an identifier that is adapted to provide identification data of the cover that is automatically communicated to the host device.

8. The method according to claim 7 comprising a receiver that is associated with the tactile sensing device, said receiver being adapted to receive the identification data of the cover and communicate it to the host device.

9. The method according to claim 8, wherein the identifier is a wireless identifier that is adapted to transmit identification data that is received by the receiver also when the cover is still being urged towards the tactile sensing device.

10. The method according to claim 7, wherein the identification data communicated to the host device is adapted to urge the launch of a software program on the host device that is adapted to operate with the identified cover.

11. The method according to claim 10, wherein the tactile sensing device is associated with a receiver that is adapted to communicate with the host device and the identification data is transmitted from the identifier to the receiver in order to identify the cover that was placed on the tactile sensing device.

12. The method according to claim 11, wherein prior to the launch of a software program on the host device that is adapted to operate with the identified cover, a driver on the host device checks if a software program is already running on the host device.

13. The method according to claim 12, wherein if a software program is already running on the host device then the driver checks if the already running software is adapted to operate with the identified cover.

14. The method according to claim 13, wherein if the already running software is not adapted to operate with the identified cover then the driver indicates to a user operating the user interface that the already running software and the identified cover are not compatible.

15. The method according to claim 13, wherein if the already running software is not adapted to operate with the identified cover then the driver terminates the operation of the already running software and launches the software program that is adapted to operate with the identified cover.
